(19) United States
(12) Patent Application Publication
(10) Pub. No.: US 2014/0151396 A1
(43) Pub. Date: Jun. 5, 2014

(54) Lidding, Pull-tab and Self-opening System

(71) Applicants: Charles Stehli, JR., Maple Glen, PA (US); Donald Pansier, Green Bay, WI (US); Robert Dematteis, Grass Valley, CA (US)

(72) Inventors: Charles Stehli, JR., Maple Glen, PA (US); Donald Pansier, Green Bay, WI (US); Robert Dematteis, Grass Valley, CA (US)

(21) Appl. No.: 14/233,100

(22) PCT Filed: Jul. 7, 2012
(86) PCT No.: PCT/US2012/045871

§ 371 Date: Jan. 15, 2014

Related U.S. Application Data
(60) Provisional application No. 61/572,609, filed on Jul. 18, 2011.

(51) Int. Cl. B65D 41/32; B67B 7/00

(52) U.S. Cl. CPC B65D 41/32; B67B 7/24
USPC 222/82; 220/260; 220/270; 220/254.1; 222/321.1

(57) ABSTRACT

Systems and methods are disclosed for a container with a lower wall portion to contain a liquid, gas or viscous material therein; an upper flange having an upper flange region; and a lid attached to the upper flange with at least a first region with a first bond strength to survive a drop test, and a second region with a second bond strength for easy opening.

The present invention claims priority to Provisional Application Ser. No. 61/520,573 filed Jun. 8, 2011, Provisional Application Ser. No. 61/572,609 filed Jul. 18, 2011, and Provisional Application Ser. No. 61/574,392 filed Aug. 1, 2011, the contents of which are incorporated by reference.

### BACKGROUND OF THE INVENTION

The invention relates generally to lidding applications and self-opening systems that may be used with containers, and more specifically it relates to lidding systems and a unique self-opening system for a stemless dispensing system.

### DESCRIPTION OF RELATED ART

Lidding is commonly used with flexible plastic containers such as those used for yogurt and apple sauce and like the containers of our co-pending patent application U.S. 61/520,573 that illustrates the EZ-Flo container. Generally speaking, smaller containers use in retail, such as yogurt, apple sauce and so on, require a certain degree of drop test qualities, but are not of great significance compared to larger container applications. Regardless of size, most lidding today consists of a foil laminate, a plastic material, or a combination of paper board and plastic. Typically the various forms of lidding is sealed to the container by sealing the plastic laminate layer to the containers top rim, or by the use of an adhesive. It is understandable that these methods may be inadequate for certain institutionalized applications in that they don't have sufficient drop test strength or may be subject to cross contamination when opened and afterward.

The general challenge for producers filling these containers is to find a happy medium of seal strength and yet maintain peelability of the lidding. If a seal is too strong, it is difficult to open, and if it is easy to open, it will not be strong enough to withstand a drop test. Various types of films may be used in combination, either laminated or co-extruded, in an attempt to satisfy this dual objective, but generally speaking one sacrifices the other. A partial solution is the use of a lidding film with directional tear but still it only partially solves the problem at hand.

Common applications for lidding include smaller containers for products such as yogurt, apple sauce, and the like, however there are other applications for lidding that are emerging for example dispensers and containers that may be used for various flowable materials such as sauces, lotions, liquid soap, and so on. Some flowable solutions of a thick, dense viscosity such as paste, relishes, and sour cream, even exceptionally thick vicosities such as lard, guacamole, grease, spackling compounds, even Portland cement solutions may benefit from the use of the new generation of dispensers as described in our pending patent application '573 and herein. It should be understood that flowable contents may also include dry products as long as they are of sufficiently small particles to flow from a container, through some form of dispensing means. For example, this may include flowable contents such as steel ball bearings, providing the particle size is somewhat less than any dispensing restrictions such as tubing, pump systems, valves and so on.

The majority of these existing flowable products, regardless of density, are dispensed in a variety of means depending on needs. For example bulk sauces may be in a large plastic bottle with a typical pump dispenser, or may be in a #10 can with the means of dispensing being a pump system mounted atop. Containers dispensing flowable contents typically use some form of pump or spray unit mounted atop with a stem that extends to the bottom of the container. The stem, or course, provides a means to extract the contents being dispensed as it is used up. All of these prior art containers are typically refilled after the majority of the contents are used up. As cited in our co-pending application, the significant health and sanitation risks are readily evident with trans-filling, adding new contents to older contents, the use of kitchen implements to scoop, spread, etc., all of which methodologies may cause cross-contamination.

A lidding system that improves the ability to withstand drop tests and is yet easy to open, would be desirable to the trade. A lidding system that has a self-opening means and requires no pull-tab opening and overcomes the numerous problems associated with prior art lidding such as inferior drop tests, the reduction of potential of cross contamination, and likewise be simple for user to open and use would be valuable to the trades and many other applications. A pump or spray system mounted atop a container that doubles as a self-opening lidding system would be valuable to the trades and many other applications, in particular if the pump or spray unit was stemless. A lidding system that may be used effectively with the new generation EZ-Flo dispensing systems that is easy to use and eliminates the substantial health and sanitation liabilities would be valuable to the trades and many other applications.

### BRIEF SUMMARY OF THE INVENTION

Systems and methods are disclosed for a container with a housing to contain a viscous material therein, the housing having a flange; and a lid attached to the flange in various configurations to effect efficacious opening while maintaining high strength qualities to withstand a drop test. Various other related self-opening means and pump and spray systems are also disclosed.

The lidding, self-opening and stemless dispensing system of the preferred embodiment overcomes the problems associated with prior art. It provides a unique means of lidding a container with superior strength qualities to withstand substantial drop tests. Likewise, it is easier for a user to open the lid, and in one version the lidding is self-opening and completely eliminates the need to have a pull tab or any form of lid removal. Last, these features can be incorporated in a stemless pumping and spray system that reduces waste and enhances sanitation properties.

One version of the preferred embodiment is made of a traditional pull-tab lid but with two bonding-sensitive regions; a strong bonding region on an inner periphery and a weaker bonding region on an out periphery. This is accomplished by the use of differential adhesives, differential sealing properties, treat qualities and so on.

A second version is accomplished by having a first lid with strong bonding qualities throughout, with a second lid centrally located within the first lid with somewhat weaker bonding quality. Thus the first lid adheres to withstand severe drop tests, whereas the second lid is easier for a user to open.

A third version utilizes a lidding system that has a strong bond throughout, with two pre-weakened, tear initiation points outside the strong bonded region, thus enabling the container to withstand substantial drop tests. The pre-weakened, tear initiation points, allows the user to easily open a portion of the lidding for subsequent dispense.

A fourth version utilizes a single lid that has a strong bond throughout, thus enabling the container to withstand substantial drop tests, with a unique self-opening system that is part of the cap that punctures or severs a portion of the lid, thus allowing it to subsequently dispense. It is adaptable to any number of pump and spray systems, manual or electric.

All four versions are adaptable to existing containers and to the new generation of EZ-Flo containers and may be made with stemless pumps and sprays. The facilitating of the self-opening system allow contents to maintain substantially the same quality from the instant they are filled to the time they are used by a user. There is no exposure to air during this time, nor after the lidding is self-opening, not until the actual contents are dispensed through the pump, spray head, valve, nozzle and so on. In all four versions the users are able to facilitate the opening of the lid without negatively affecting the drop strength. The importance of such a system is evident as more containers are being used are made of lighter gauged plastics, which reduces raw material content and costs. The challenges for superior, high quality lidding on lightweight containers becomes more important. Likewise, with the fourth version, the complete elimination of manually opening a container and then attaching it to a dispenser, adds substantial sanitization and health benefits. In such an application there contents of the container is not exposed to human contact or the atmospheres until after the container is sealed inside a dispenser. Thus, the contents from the time they are filled to the time they are dispensed retain superior sanitization properties.

The objectives of the preferred embodiment are to provide:
1) A lidding system that may withstand severe drop tests;
2) A lidding system that is easy to open by a user;
3) A lidding system that requires no opening by a user;
4) A lidding system that provide complete covered protection from filling to opening;
5) A lidding system that provides in combination superior drop test qualities and easy to open qualities;
6) A lidding system that may be used with small containers for individual servings.
7) A lidding system that may be used with larger bulk containers with any dispensing system.
8) A lidding system that may be used with larger bulk containers with a dispensing system as described herein.
9) A lidding system that may be used with heavy, dense flowable contents.
10) A lidding system that may be used with heavy, dense flowable contents with any dispensing system.
11) A lidding system that may be used with heavy, dense flowable contents with a dispensing system described herein.
12) A lidding system that is cost effective;
13) A lidding system that is intuitive to use;
14) A lidding system that is easy to manufacture;
15) A self-opening system for lidding;
16) A stemless pump unit;
17) A stemless spray unit;
18) A self-opening system for lidding that is also a stemless pump unit;
19) A self-opening system for lidding that is also a stemless spray unit, and;
20) A stemless cap that may be used to dispense flowable contents.

Furthermore, it is an object of this application to illustrate the preferred embodiments and broadly state the methodologies that may be used in order to describe the primary objective being accomplished.

### BRIEF DESCRIPTION OF THE DRAWINGS

FIG. 1 is a perspective view of the preferred embodiment illustrating the components that make up a first set of preferred embodiments.

FIG. 1A is a perspective view of the preferred embodiment illustrating the lid being removed from the invention in FIG. 1.

FIG. 2 is a perspective view of the preferred embodiment illustrating the components that make up a second set of preferred embodiments.

FIG. 2A is a perspective view of the preferred embodiment illustrating the lid being removed from the invention in FIG. 2.

FIG. 3 is a perspective view of the preferred embodiment illustrating the components that make up a third set of preferred embodiments.

FIG. 3A is a perspective view of the preferred embodiment illustrating the lid being removed from the invention in FIG. 3.

FIG. 4 is a cross-sectional view of the preferred embodiment with the lid opened, inserted into a dispenser, and with a stemless dispensing top attached.

FIG. 5 is a cross-sectional view of a top cap of the preferred embodiment illustrating the components that make up a self-opening system.

FIG. 6 is a cross-sectional view of a top cap of the preferred embodiment illustrating the components that make up a variation of the self-opening system.

FIG. 7 is a cross-sectional view of a top cap of the preferred embodiment illustrating another variation of the self-opening system.

FIG. 7A is a cross-sectional view of a top cap in FIG. 7 being deployed by pressing downward.

FIG. 8 is a perspective view of a variation of the preferred embodiment illustrating the components that make up a lidding system that includes a dispensing nozzle.

### DETAILED DESCRIPTION

### A. Description of the Preferred Embodiment

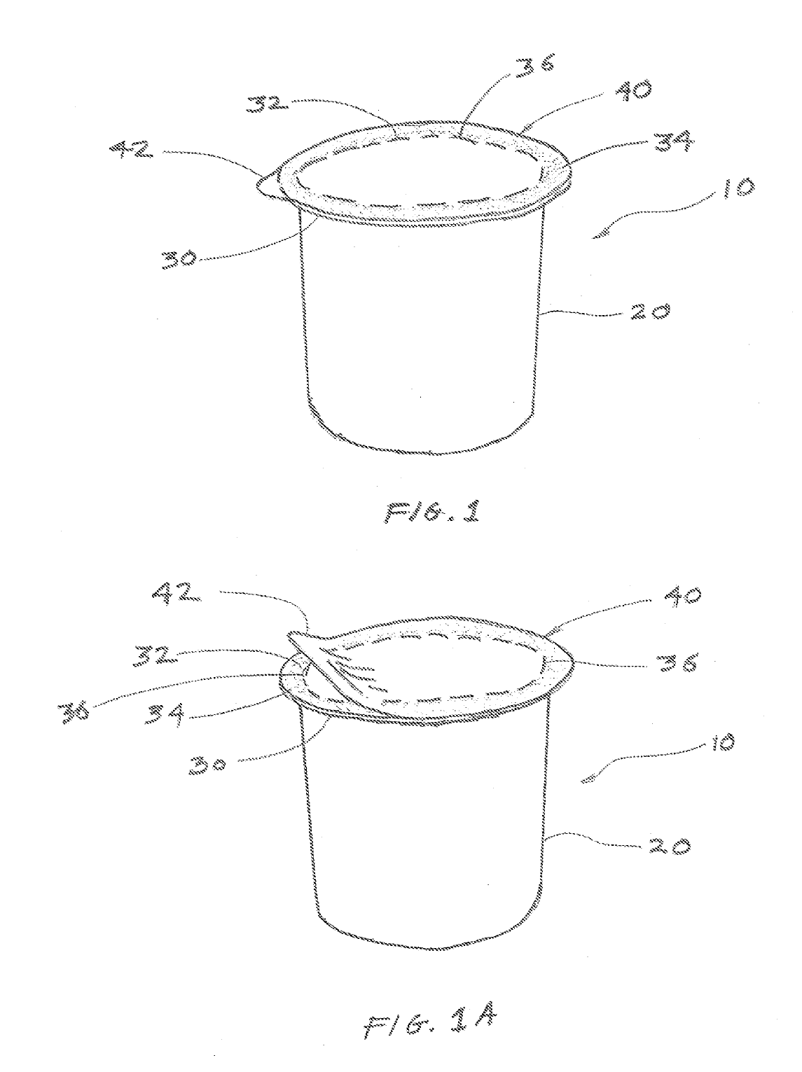

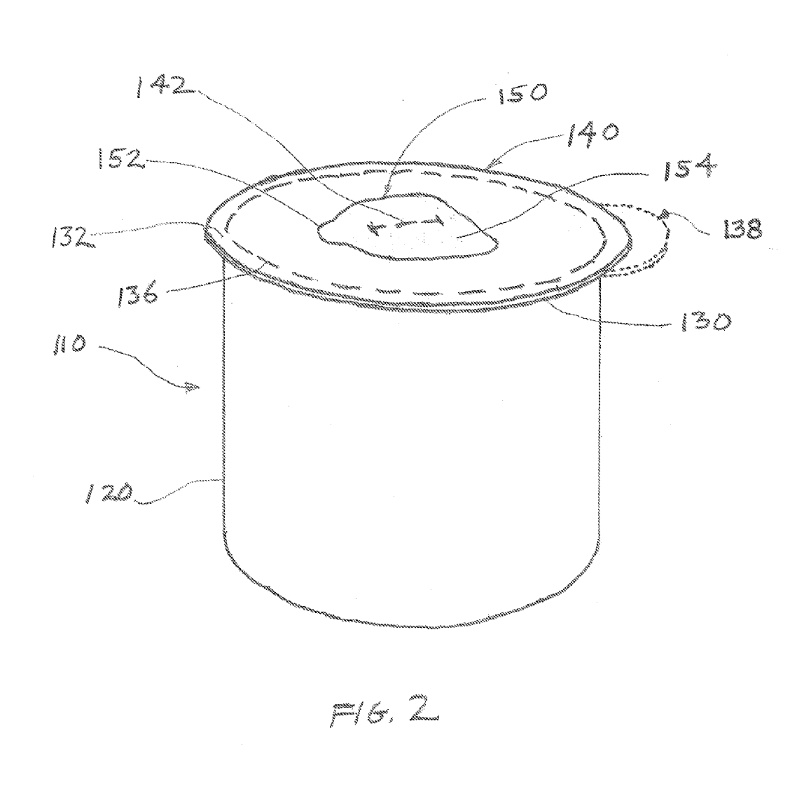

In FIGS. 1, and 1A, container 10 has a walled lower portion 20, a horizontal upper flange 30, and a lid 40. Lid 40 has a pull-tab 42 and is bonded to upper flange 30 at regions 32 and 34. As illustrated, region 32 (marked by cross-hatching) represents a stronger bonding region and region 34 (marked by diagonal lines) represents a weaker bonding region. As a user pulls up on pull-tab 42 separation of the lid 40 from upper flange 30 is facilitated by the separation at the weaker bonding region 34. As separation commences, lid 40 is then more vulnerable to release from flange 30 at its stronger bonding region 32.

As illustrated in FIG. 1A, lid 40 is partially separated at the weaker region 32 and is just beginning to separate at the stronger region 34. This configuration with the stronger region 32 inside the weaker region 34 withstands substantial internal pressures that may exist when subjected to severe drop tests. As is commonly understood, the most vulnerable portion of a seal when subjected to drop tests is along the inner junction of a seal, in this case, along the inner junction 36 of strong bonding region 32. Thus it has superior drop test qualities, yet easier to facilitate lid removal by separation from the weaker outer region prior to releasing from the inner strong bonding region.

The bonding that creates stronger and weaker bonding regions illustrated in FIGS. 1 and 1A may be accomplished by variables in heat temperatures, pressures and dwell time. It may also be accomplished with different types of adhesives or applications of adhesives with different thicknesses, application pressures and so on. Likewise, the use of electrostatic treat to the film or flange in a locale may contribute to the weakening of a heat applied bond, whereas the lack of treat may create a strong bonding between the two components. It may also be accomplished with a combination of any of the above.

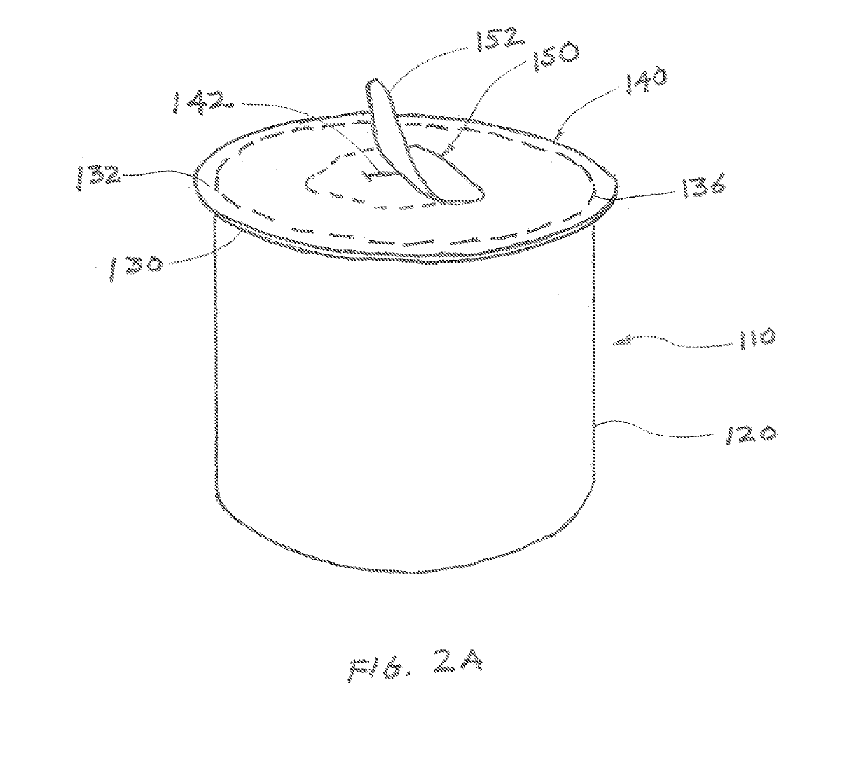

In FIGS. 2 and 2A container 110 has a walled lower portion 120, a horizontal upper flange 130, a first lid 140 and a second lid 150. First lid 140 as illustrated is bonded to upper flange 130 at region 132, which bond is considered a strong bond able to withstand substantial drop tests. Second lid 150 has a pull-tab 152 and is securely bonded to first lid 140 at a generally medial location 154 (cross-hatched lines), which bond is not considered as strong as that at region 132, but the overall coverage of the bonding means provide an overall substantially strong bond to withstand severe drop tests. Also illustrated in FIG. 2 is an external handled ear 138 (illustrated by dotted lines), which is an extension of flange 130. Handled ear 138 may be used with larger, heavier contents to help a user set container 110 into a dispenser base. An opposing handled ear may also be located opposite ear 132. Ear 138 may have a centrally located handle hole or some other form or ridge to help provide a gripping means. Likewise, handled portions may be attached to, or may be an inherent part of, other surface areas along the wall 120.

As illustrated in FIG. 2A, when a user pulls up on pull-tab 152 separation of second lid 150 from first lid 140 leaves an opening 142 suitable to access the contents of container 110. This configuration with the strong bond 132 withstands substantial internal pressures that may exist when subjected to severe drop tests since the most vulnerable portion of the seal when subjected to drop tests is along the inner junction of a seal, in along the inner junction 136 of bonding region 132. Thus it has superior drop test qualities, yet easier to facilitate lid removal by removal of second lid 150 from the centrally located region of first lid 140.

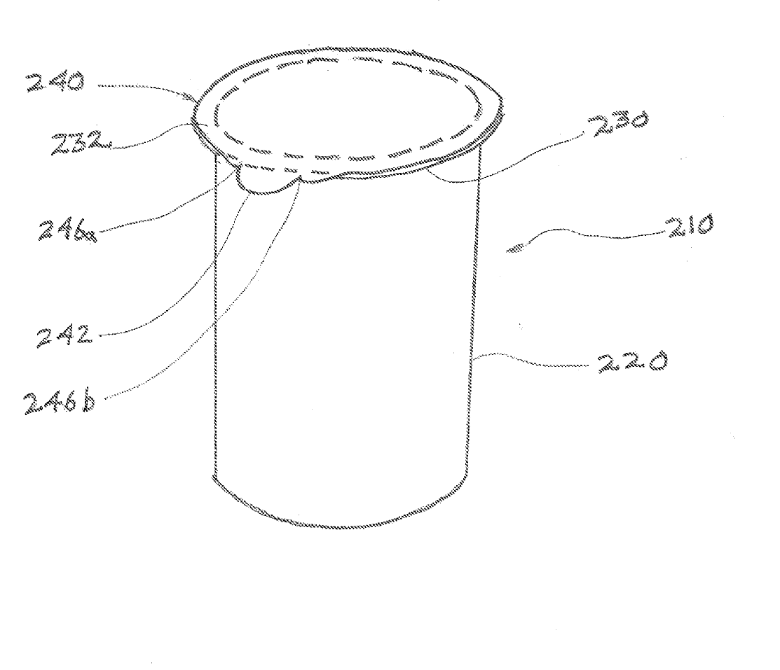

In FIGS. 3 and 3A, container 210 similar to containers 10 and 110 and is also suitable for use in any myriad of applications as described herein. Container 210 has a walled lower portion 220, a horizontal upper flange 230, and a lid 240. Lid 240 has a pull-tab 242 much like that in FIGS. 1 and 1A and is bonded to upper flange 230 at region 232 which bonds lid 240 throughout the entire flange 230, much like the strong bonding regions previously described in order to withstand substantial drops. Proximate to pull-tab 242 are two tear initiation points 246a and 246b, which two points represent weakened points that will initiate a tear across lid 240 when tab 242 is pulled up and open and is shown in FIG. 3A (illustrated by arrows). Upon completion of the opening process, the tear line will typically continue directly across lid 240 and terminate on the opposite side of container 210.

The tear initiation points 246a and 246b would typically be located in a location that will propagate straight line tears consistent with the film qualities and film orientation. For example, blown and cast films that may be used in lidding materials and may be oriented to tear in the machine direction or traverse direction. Many factors, such as blow-up ratios, or stretch ratios in blown and cast films may be used to create a desirable predetermined direction of a tear. This may also be accomplish with any number of pre-creasing methodologies and other technologies. While straight line tear is not a requirement for use with the preferred embodiment 210, it would tend to provide the desired outcome.

The tear system illustrated in FIGS. 3 and 3A provide the advantage of very quickly removing a lid portion suitably large for dispensing and receiving a suction tube or any other means of dispensing as described in our pending '573 application. It also provides the advantage of not having to remove the entire lid, only the desired portion. When removing the top along a predetermined line consistent with the film orientation, it becomes an easier operation for the end user compared to other forms of lidding. Likewise, with a strong seal all about the upper flange 230, only a small portion of that strong needs to be broken in order for the user to gain access to the contents therein.

This use of container 210 as described in FIGS. 3 and 3A (or any others described herein) is not restricted to size. Similar benefits may be evident when used in containers as large as 55 gallon drums, 5 gallon tubs and so on. The exceptional qualities of using a highly durable collapsible container or invertible liner as described in the new generation of dispensing systems in the pending '573 application, may be a huge asset to various industries to eliminate the use of metal containers, avoid the serious consequences of cross contamination (food, chemical or otherwise), and substantially reduce waste. The overall health and environmental impact may be significant.

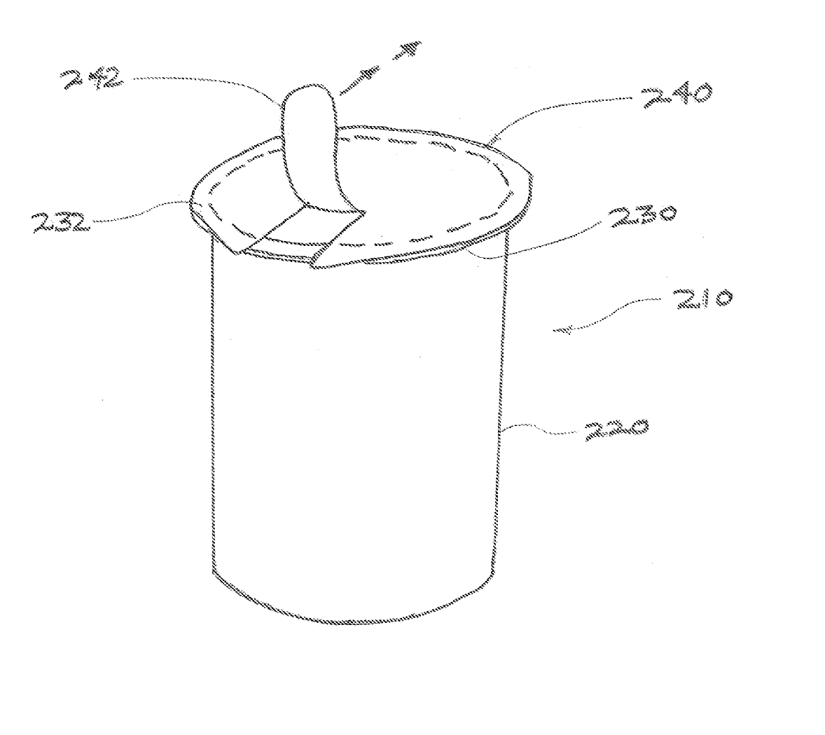

In FIG. 4 the preferred embodiment container 310 is much like that of any of those illustrated in the FIGS. 1, 1A, 2, 2A, 3, and 3A, and has been placed inside dispenser base 350. Dispenser base 350 is designed to receive lidded containers with flanges and may or may not have a one way valve 352 to allow air to enter during the dispensing operation, but not to exit. At its top outer rim is male threaded portion 354. Attached atop dispenser base 350 is dispenser top 360, which in this case is a pump system, much like that of existing pump systems used to dispense flowable contents C (indicated by small circles) such as sauces, liquid soaps, high viscosity solutions, and so on. Dispensing top 360 consists of a cap member 361, a sealing gasket 362, a threaded female portion 364, a stemless tube 366, a stemless base 367, and an upper hollow pump plunger 368.

Operation of the pump dispenser 360 is much like that of traditional pump systems and may accompany the use of springs, flexible rubber or metallic components, etc. in order to effect the return of the plunger after pumping. Likewise it may not use a system for return and may consist of any number of pump systems such as an up and down motion, lever action and so on. This dispensing top 360 may be in the form of a spray system for fluids or a one-way valve system using flexible material allowing contents to dispense out such as a duckbill valve. Such a one-way valve system may be like that used in the EZ Flo system, which closes off after dispensing and does not allow air to enter afterward. Whether the system uses pumps, sprays, or valves it is generally preferred that they dispense flowable contents and then don't allow air to enter inside afterward. For example, the entering of air may speed up spoiling of foodstuffs, harden caulking, set up glues and so on.

As illustrated, container 310 has its lid removed and is secured inside dispenser base 350, which is affixed to dispensing top 360 by firmly screwing top 360 onto dispenser base 350 and forming an airtight seal with the use of a flexible washer 352 seating tightly against flange 330 in between the two components 350 and 360. Once secured an air tight system is formed and the dispensing top can immediately be put into use. Upon pumping plunger 368, flowable contents are dispensed. As illustrated, flowable contents C has filled container 310 completely with little or no air inside. When the pumping action (or dispensing action as the case may be with sprays and one-way valves) is initiated, flowable contents C are drawn up inside the stemless base 367 though plunger tube 369 and out tip 370 (indicated by short arrows).

This dispensing action draws flowable contents off the top of container 310 and since it is in an airtight environment, container 310 will collapse inwardly as contents are dispensed. Since there is no air inside container 310 it will continue to shrink in size until the contents are dispensed. This may be much like that of the EZ Flo system or may be a system that allows the container to collapse upon itself in any other manner or fashion. For example, a bag type container may simply collapse inwardly and flatten itself. Regardless of the type of container, round thermoformed, a flat bag filled and sealed, a preformed pouch, and so on, the flowable contents are dispensed upward towards the dispensing tube, pump, spray or valve, without the requirement of having the container being turned upside down, or the pump assembly having a stem that reaches all the way to the bottom. In all of these applications, the airtight environment, which allows air to enter the dispenser base through valve 352, will allow contents to efficaciously dispense without the use of a stem extending to the bottom of the container.

The preferred embodiment illustrated in FIG. 4 may have a wide variety of shapes and additional attributes to enhance its ability to remain airtight and dispense as desired. For example, it may be advantageous to have an oval shaped bottle and to use a container made from a flat bag that efficiently fills the interior. Likewise, the container may have a nozzle, or dispensing tip that fits airtight through a dispensing cap opening, such as the one-way valve and dispenses contents while the dispenser is being squeezed instead of being pumped or sprayed. This nozzle or tip may be an inherent part of the container itself, or may be a fitment. Such an application uses the same principles as described herein, but in this variation, the nozzle (or fitment) would be disposable. Enhancements to the dispensing system may also include one or more one-way valves to improve the air-tight environment or may include containers that are already affixed inside the dispenser. It may also be used with existing metal cans and plastic containers with a dispensing top that snaps securely onto the lid. Any number of combinations may be used to provide the desired dispensing system that provides the desired outcome based on the type of contents being dispensed.

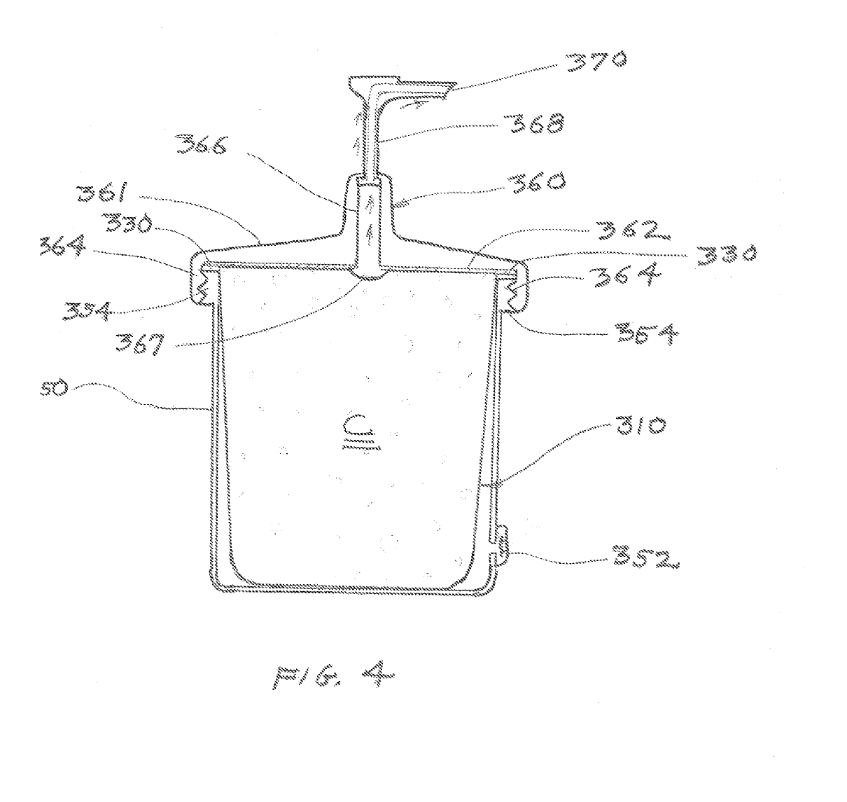

In FIG. 5 the preferred embodiment dispensing top 460 provides a self-opening means that may be used with any number of lidded containers as previously described in the FIGS. 1, 1A, 2, 2A, 3, and 3A, and may include certain prior art containers as well. Dispensing top 460 consists of a cap portion 461, sealing gasket 462, a threaded female portion 464, a stemless tube 466, a self-piercing stemless base 467, with base has a sharpened edge, an upper spray head 468 a support shaft 469, and return springs 465a and 465b. Operation of the spray head is much like that of any traditional spray system and may accompany the use of springs, flexible rubber, elastic bands, or metallic components, and so on. Likewise it may use any other form of pump system as disclosed in FIG. 4, or valve or nozzle system as disclosed in FIGS. 1, 1A, 2, 2A, 3 and 3A, or in our co-pending applications and so on.

To enact the self-opening system, first an un-opened lidded container is placed in a dispenser base (not shown) in more or less the same manner as illustrated in the previous FIG. 4, with the main difference being that the lid has not been opened. Second, the user screws the dispensing top 460 onto the dispensing base. Third, the used pushes down on spray head 468 and the self-piercing base 467 is pushed down and thus, pierces the lidded film (not shown) lying horizontally, perpendicular, and directly underneath. This piercing operation is illustrated by the downward arrows. Upon completion, the self-piercing base retracts back upward into its original position with the help of return springs 465a and 465b. Once completed the user may then begin spraying (dispensing) the contents (or pumping or squeezing through a valve as the case may be) as desired.

The piercing base 467 may in be any number of configurations, with serrated edges, prongs, and so on. It may also attached to the stemless tube or an inherent part of it. The spray head, once again may be a pump, valve, nozzle, and may take on any number of shapes, including a low-profile stemless tube for simple dispensers used on squeezable contents such as sauces, mayonnaise, and so on. The unique combination of the self piercing system of the preferred embodiment and the pre-filled lidded containers is ideal for any product that requires absolute sanitation. In such a case the contents are never touched by a human nor do they come in direct contact with air or other atmospheres from the time they are filled—to the time the container is pierced and used. As the reader can see, the contents do not reach air or an atmosphere until after it has been dispensed.

This phenomena is exceptionally desirable in food applications and overcomes one of the basics contamination issues associated with sauces and foods used in restaurant and home applications. It is easy to understand that food preservation qualities are also maximized since no there is no interim contact with any possible pollutants in the air. This is also invaluable for uses with glues, caulking, paints, and any alcohol based product that may be subject to rapid evaporation, hardening, and spoilage.

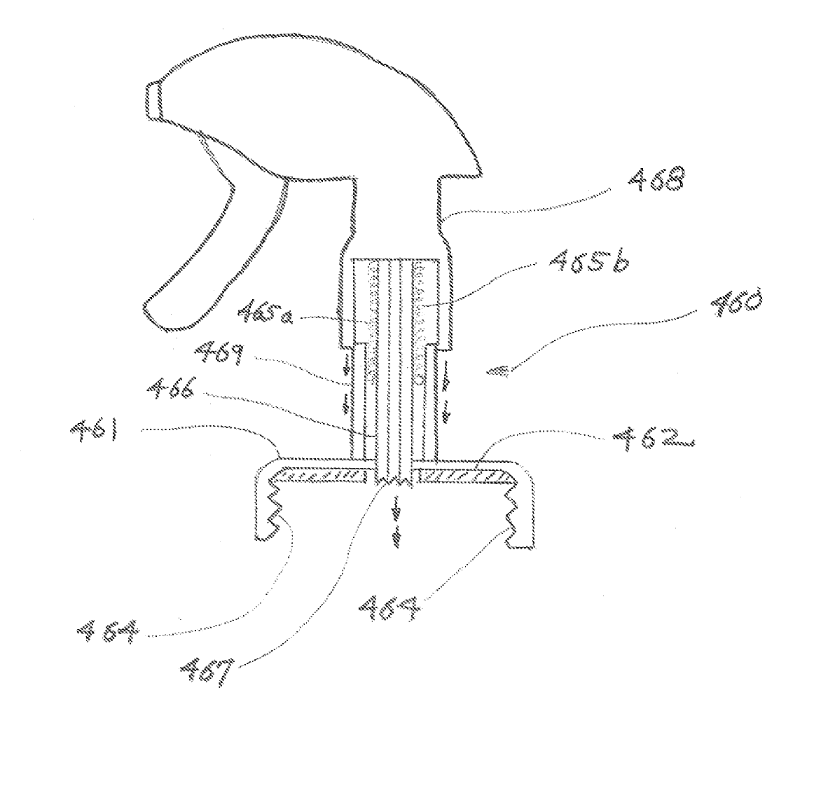

In FIG. 6 the preferred embodiment dispensing top 560 provides an alternate self-opening means that may be used with the lidded containers previously described herein in the FIGS. 1, 1A, 2, 2A, 3, and 3A, and may also include any number of prior art containers. Dispensing top 560 consists of a cap member 561, sealing gasket 562, a threaded female portion 564, a duck bill valve 566, and a round self-piercing base 567. Self piercing base 567 may be a serrated edge, sharpened edge, wave-form or otherwise providing it has the sufficient sharpness to pierce a lidding film. Operation of the dispenser cap 560 is much like that of any dispensing system as previously described and as described in our co-pending patent '573 application and may be in the form of any number of valves, nozzles, and so on. Likewise it may use any form of spray or pump system as previously disclosed herein instead of a one-way valve.

To enact the self-opening system of the dispensing top 560, first an un-opened lidded container is placed in the dispenser base (not shown) in more or less the same manner as illustrated in the previous FIG. 4, with the lid being unopened. Second, the user screws the dispensing top 560 on the dispenser base and the act of screwing onto the dispenser base causes the round self-piercing base 567 to puncture a hole in the lidded film (not shown). Any number of types of blades may be sufficient for this operation and may include a sharpened edge that is slightly tilted (an oblique, irregular shape, or pointed at one edge much like the beak of a predator bird such as a hawk or eagle) so that it pierces only a partial part of the circular cut made in the lidding film and thus allowing the cut portion to remain in tact with the main lidded portion.

As described in FIG. 6, the self-piercing base 567 may be attached to the cap 561 itself, the valve 566 or even the gasket 562. The only consideration is that it is fixedly secured to the dispensing top 560 and is a location that will effect a circular aperture when dispensing top 560 is secured to a dispensing base.

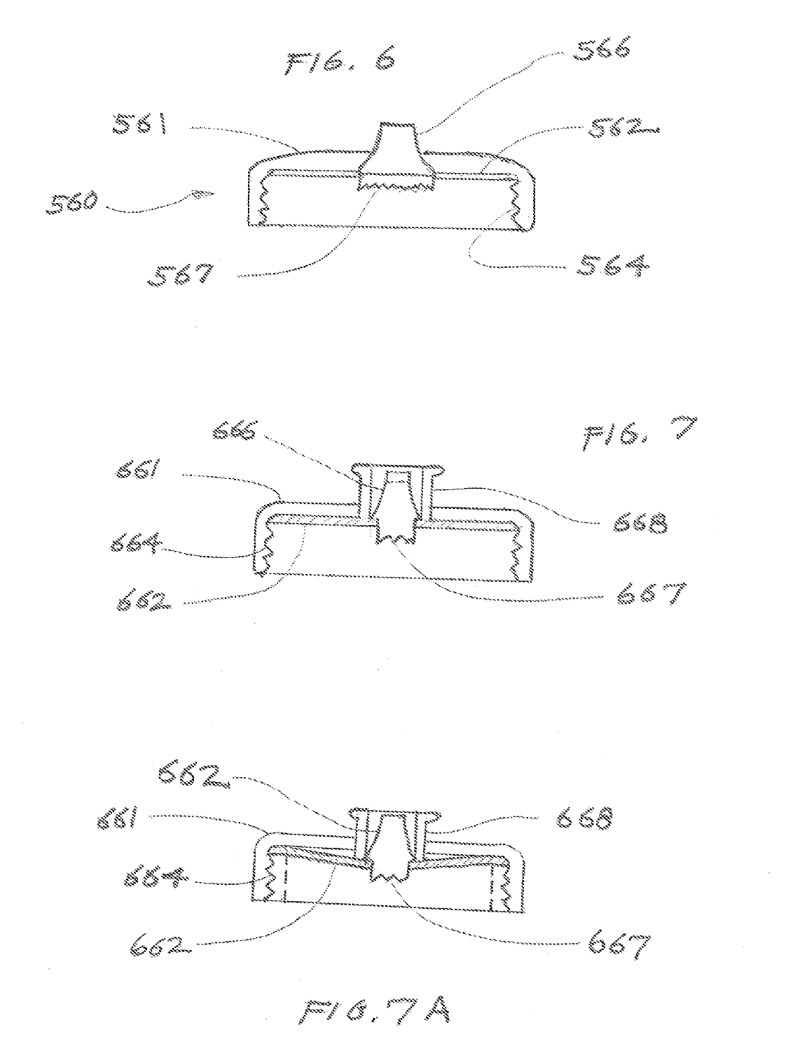

In FIGS. 7 and 7A the preferred embodiment dispensing top 660 provides yet another self-opening means that may be used with the lidded containers previously described herein in FIGS. 1, 1A, 2, 2A, 3, and 3A, and may also include any number of prior art containers. Dispensing top 660 consists of a cap member 661, sealing gasket 662, a threaded female portion 664, a duck bill valve 666, a self-piercing base 667, and an upper plunger 668. Sealing gasket 662 is ideally made of a material such as plastic, silicon, or rubber that has a spring like effect, in other words, a good memory. Self-piercing base 667 may be a serrated edge, sharpened edge, wave-form or otherwise as previously described providing it has sufficient sharpness to pierce the lidded film.

To enact the self-opening system of dispensing top 660, first an un-opened lidded container is placed in the dispenser base (not shown) in more or less the same manner as illustrated in the previous Figs., and maintaining its unopened disposition. Second, the user screws the dispensing top 660 on the dispenser base until tightened firmly against sealing gasket 662 (as shown in FIG. 4). Third, the user pushes downward on upper plunger 668, which downward motion pierces the immediately underlying lidding film. As illustrated in FIG. 7A, the sealing gasket 662 is stretched downward and upon release of plunger 668 by the user, it springs back into its original horizontal disposition (FIG. 7). In this piercing operation, sealing gasket 662 acts as a return spring returning plunger and self-piercing base to its original disposition (FIG. 7).

The self-piercing base as illustrated in FIGS. 7 and 7A may be attached directly to the duckbill valve or to the plunger. It may even be attached to the gasket or some form of assembly thereof. The objective is simple, that is, to provide a self-piercing system that utilizes the sealing gasket as a return means. In this way, and in all Figs. Illustrating the self-piercing, self-opening systems, the self-piercing base may recede above the sealing gasket and completely out of the way of the dispensing operation. In other words, it may be hidden up into the upper cap area itself. The principle exhibited in the preferred embodiments described are not limited to the specific location, attachment or connections of the components and elements that make up the self-opening systems.

As with the other self-opening systems, the preferred embodiment in FIGS. 7 and 7A have all the same benefits and values. Likewise, its simplicity makes it most appropriate for food service outlets where productivity is important. In fact, in every case illustrated herein, the use of the preferred embodiment improves productivity substantially due to ease of use and eliminating the need to trans-fill contents, wash out containers afterward and so on. Operation of dispenser cap 660 is much like that of any dispensing system as previously described and as described in our co-pending '573 patent application and may be in the form of any number of valves, nozzles, and so on. Likewise it may use any form of spray or pump system as previously disclosed herein.

As described in these self-opening systems, the puncture (opening) made in the lidding film may be a round shape, an X formation, a straight slit, or any other number of shapes and configurations, providing it punctures a sufficient portion of the lidding film to allow contents to freely be dispensed. The sharpened edge of the piercing base may be any type of edge suitable for piercing thin plastic lidding film, including serrated edges, 1, 2, 3 prongs or more, an offset sharpened edge; it may be round, square, rectangular or otherwise. The depth of the draw when piercing may depend on the application, the size of the container and the thickness of the film. For example, when used with a 55 gallon drum, the film thickness may be as thick as 2 mils and may require a draw as great as 2″ to 3″. Whereas a film used on a small 16 oz. size sauce container may be as short as ¼″ to ½″. The use of return springs or means may or may not be used. A return system may be effected with the use of springs, levers, gaskets, elastic bands, and bushings made of a material with a memory and so on.

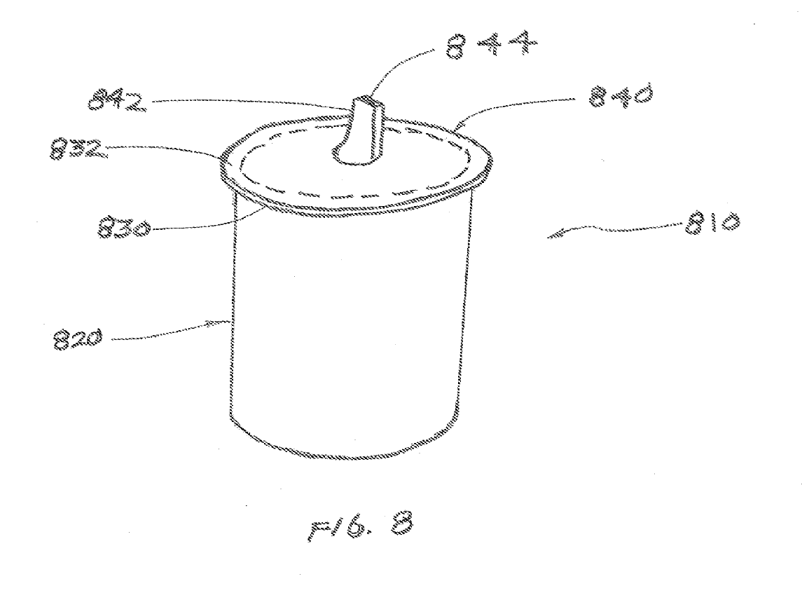

In FIG. 8, container 810 is similar to the prior art containers described herein and is also suitable for use in a myriad of applications as described herein. Container 810 has a walled lower portion 820, a horizontal upper flange 830, and a lid 840. Lid 840 has a fitment 842, which in this case is a one-way duckbill valve. Lid 840 is bonded to upper flange 830 at region 832 which bonds lid 840 throughout the entire flange 830, much like the strong bonding regions previously described in order to withstand substantial drops. The fitment 842 may or may not be of the disposal variety and may be in any number of suitable configurations for dispensing contents inside container 810. Typically fitment nozzle 842 would be sealed (not shown) at its opening 844, with a cap, a simple pull-tab to effect opening, or by cutting the tip (as may be desirable with contents such as caulking), and so on. The means of opening fitment 842 is not to be construed as limited to those described herein and may by of any number suitable varieties commonly or uncommonly known in the trade.

The fitment 842 and the lid 840 in FIG. 8 may also be made in one piece. In other words, formed into the lid itself is a dispensing nozzle that serves as a one-way valve, such as a duckbill valve, or so on. The lid may also be in any size or shape based on the container's construction. For example, if the neck has been narrowed, such as that of a traditional bottle, the lid may likewise be of a much smaller diameter (or size). Likewise the size, width and opening on the nozzle may be in a multitude of sizes, shapes and materials, based on what is being dispensed.

The use of container 810 may be in a dispenser described herein, in our co-pending patent application '573, or our co-pending patent application entitled, Flowable Dispenser, System and Filling Processes (FDSFP). The use of the preferred embodiment 810 would include: 1) filling a container with contents; 2) sealing it with a strong seal; 3) securing the container to a dispenser, so that; 4) the nozzle (fitment end) may then be opened and dispensing of the contents may begin. Obviously it would be desirable to have the dispenser configured in a form that is consistent with the airtight dispensers we have disclosed in this patent application, the '573 application, or the FDSFP application. In doing so, it takes advantage of the significant benefits of a sanitary, airtight environment.

The means of dispensing described herein likewise has no size limitations. It may be used in small glue applications of a few grams up to large 55 gallon drums, even larger if desirable. The pumps may be manual, operated by electricity, compressed air or other means. An electrical pump means for example, would be ideal for printing inks. The contents are only limited by the imagination of the manufacturer and by the ability to make the contents flow from one point to another, regardless of being liquid, dry, solids or otherwise.

The preferred embodiment may be manufactured in any number of materials. Generally speaking plastics provide the best economics, ease of forming, plus its sanitation qualities are excellent. However metal components may certainly be effective with larger applications dealing with long-term durable dispensing applications that may have to last for many years.

Last, the uses for the preferred embodiments contained herein are unlimited and most excellently suited for foods, medical, and industrial and commercial applications, glues caulking, and so on. The spirit of the preferred embodiment provides a breadth of scope that includes all methods of making and using it. Any variation on the theme and methodology of accomplishing the same that are not described herein would be considered under the scope of the preferred embodiment.

1. A container comprising:
a lower wall portion to contain a liquid, gas or viscous material therein;
an upper flange having an upper flange region; and
a lid attached to the upper flange with at least a first region with a first bond strength to survive a drop test, and a second region with a second bond strength for easy opening.

2. The container of claim 1 wherein:
the upper flange region contains a second region with a weak bond strength located outside the first region to easily open the container when pulling on a tab.

3. The container of claim 1 wherein:
the lid comprises a second centrally located lid attached thereon and openable by pulling on a tab connected to a second lid, and wherein the second centrally located lid has coverage to survive the drop test.

4. The container of claim 3 wherein:
the first lid has a pre-opening aperture lying directly below the second lid.

5. The container of claim 1 wherein:
the lid includes a tab outside the first region with the first bond strength, wherein the tab includes at least one pre-weakened point to initiate a tear across the lid.

6. The container of claim 1 further comprising:
a second outer rigid container having a durable cap with a self-opening system that punctures or severs a portion of the lid.

7. The container of claim 1 further comprising:
a second outer rigid container with a durable cap including at least one of the following: a pump system or a spray system.

8. The container of claim 1 wherein:
the upper flange contains one or more handling ears.

9. The container of claim 1 wherein:
differences in bonding strength are formed with differential adhesives, differential sealing properties, or treatment processes.

10. The container of claim 1 wherein:
the lid's film quality and orientation propagate a straight line tear.

11. The container of claim 6 wherein:
the container operates with a stemless pump or spray.

12. A dispensing system comprising:
a first container comprising a lower wall portion to contain a liquid, gas or viscous material therein; and
an upper flange seated atop a second outer rigid container with a cap that contains a self-piercing system to pierce an underlying lid membrane.

13. The dispenser of claim 12 wherein:
the self-piercing system is actuated by pushing downwardly into a lid membrane.

14. The dispenser of claim 12 wherein:
the self-piercing system is actuated by screwing a cap onto the second rigid container and piercing a lid membrane as a cap is secured on the first container.

15. The dispenser of claim 12 wherein:
the self-piercing system is an integral part of a spray head unit, or a pump unit.

16. The dispenser of claim 12 wherein:
the self-piercing system is an integral part of a nozzle.

17. A method of dispensing a material comprising:
providing a first sealed container containing a liquid, gas or viscous material therein;
sealing the container with a lidding membrane;
providing a second outer rigid container comprising a cap with a self-piercing device;
placing the first sealed container into the second outer rigid container;
securely fastening the cap to the outer rigid container and;
actuating the self-piercing device to dispense the material.

18. The method of claim 17 further comprising:
actuating the self-piercing device as the cap is secured to the outer rigid container.

19. The method of claim 17 wherein:
the cap comprises a pump or spray head.

20. The method of claim 17 wherein:
the outer container is sufficiently flexible to squeeze a liquid, gas or viscous material out of an exit port.
